(19) United States
(12) Patent Application Publication
(10) Pub. No.: US 2006/0245641 A1
(43) Pub. Date: Nov. 2, 2006

(54) Extracting data from semi-structured information utilizing a discriminative context free grammar

(75) Inventors: Paul A. Viola, Kirkland, WA (US); Mukund Narasimhan, Bellevue, WA (US); Michael Shilman, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/119,467

(22) Filed: Apr. 29, 2005

(51) Int. Cl. G06K 9/62; G06F 17/27; G06K 9/46

(52) U.S. Cl. 382/155; 382/190; 704/9

(57) ABSTRACT

A discriminative grammar framework utilizing a machine learning algorithm is employed to facilitate in learning scoring functions for parsing of unstructured information. The framework includes a discriminative context free grammar that is trained based on features of an example input. The flexibility of the framework allows information features and/or features output by arbitrary processes to be utilized as the example input as well. Myopic inside scoring is circumvented in the parsing process because contextual information is utilized to facilitate scoring function training.

### TECHNICAL FIELD

The subject invention relates generally to recognition, and more particularly to systems and methods that employ a discriminative context free grammar to facilitate in extracting data from semi-structured information.

### BACKGROUND OF THE INVENTION

Computers operate in a digital domain that requires discrete states to be identified in order for information to be processed. This is contrary to humans who function in a distinctly analog manner where occurrences typically are never black or white, but some shade in between. Thus, a central distinction between digital and analog is that digital requires discrete states that are disjunct over time (e.g., distinct levels) while analog is continuous over time. Since humans naturally operate in an analog fashion, computing technology has evolved to alleviate difficulties associated with interfacing humans to computers (e.g., digital computing interfaces) caused by the aforementioned temporal distinctions.

Technology first focused on attempting to input existing typewritten or typeset information into computers. Scanners or optical imagers were used, at first, to “digitize” pictures (e.g., input images into a computing system). Once images could be digitized into a computing system, it followed that printed or typeset material should be able to be digitized also. However, an image of a scanned page cannot be manipulated as text or symbols after it is brought into a computing system because it is not “recognized” by the system, i.e., the system does not understand the page. The characters and words are “pictures” and not actually editable text or symbols. To overcome this limitation for text, optical character recognition (OCR) technology was developed to utilize scanning technology to digitize text as an editable page. This technology worked reasonably well if a particular text font was utilized that allowed the OCR software to translate a scanned image into editable text.

Although text characters were “recognized” by the computing system, the meaning, or recognition, of the words or data that the characters represented was not. Thus, a higher level of recognition was required to not only read text characters but to also recognize words and/or data. One technique for accomplishing this is to require a user to input information into a structured form. This allows a computer to associate recognized characters or data to a particular meaning. Thus, for example, if a job applicant fills out a job application form, it can be scanned into a computer, and an OCR process can recognize the characters/handwriting. The computer knows that the first line is the job applicant's first name and, therefore, assigns those recognized characters to “first name.” Typically, this information is input directly into a database. However, when information is in an unstructured format, the computer has great difficulty in determining what the data is and where it should be placed in the database. This is a substantial problem because information is much more likely to be found in an unstructured format than in a structured format. Databases contain vast amounts of information and can provide even more information through data mining techniques. But, if the information cannot be entered into the database, its effectiveness is substantially reduced. Thus, users desire a way to obtain information from unstructured sources such as, for example, extracting personal contact, or address, information from emails or documents and the like.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to recognition, and more particularly to systems and methods that employ a discriminative context free grammar (CFG) to facilitate in extracting data from semi-structured information. A discriminative grammar framework utilizing a machine learning algorithm is employed to facilitate in learning scoring functions for parsing of unstructured information. The framework includes a discriminative context free grammar that is trained based on features of an example input. The flexibility of the framework allows information features and/or features output by arbitrary processes to be utilized as the example input as well. Myopic inside scoring is circumvented in the parsing process because contextual information is utilized to facilitate scoring function training. In this manner, data such as, for example, personal contact data, can be extracted from semi-structured information such as, for example, emails, resumes, and web pages and the like. Other data such as, for example, author, date, and city and the like can be extracted from bibliographies. Thus, the subject invention provides great flexibility in the types of data that can be extracted as well as the types of semi-structured information sources that can be processed while providing substantial improvements in error reduction.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a semi-structured information parsing system in accordance with an aspect of the subject invention.

FIG. 2 is another block diagram of a semi-structured information parsing system in accordance with an aspect of the subject invention.

FIG. 3 is yet another block diagram of a semi-structured information parsing system in accordance with an aspect of the subject invention.

FIG. 4 is an illustration of a text block as a sequence of words/tokens with assigned labels in accordance with an aspect of the subject invention.

FIG. 5 is an illustration of a parse tree for a sequence of tokens in accordance with an aspect of the subject invention.

FIG. 6 is an illustration of a reduced parse tree in accordance with an aspect of the subject invention.

FIG. 7 is a flow diagram of a method of facilitating semi-structured information parsing in accordance with an aspect of the subject invention.

FIG. 8 is a flow diagram of a method of discriminatively training a context free grammar (CFG) in accordance with an aspect of the subject invention.

FIG. 9 illustrates an example operating environment in which the subject invention can function.

FIG. 10 illustrates another example operating environment in which the subject invention can function.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The systems and methods herein provide a discriminative context free grammar (CFG) learned from training data that can provide more effective solutions than prior techniques. The grammar has several distinct advantages: long range, even global, constraints can be utilized to disambiguate entity labels; training data is used more efficiently; and a set of new more powerful features can be introduced. As an example application, the problem of extracting personal contact, or address, information from unstructured sources such as documents and emails is considered.

While linear-chain Conditional Markov Models (CMMs) perform reasonably well on this task, a statistical parsing approach as provided by instances of the subject invention results in a 50% reduction in error rate. Using a discriminatively trained grammar, 93.71% of all tokens are labeled correctly (compared to 88.43% for a CMM) and 72.87% of records have all tokens labeled correctly (compared to 45.29% for the CMM).

As in earlier work, these systems and methods also have the advantage of being interactive (see, T. Kristjansson, A. Culotta, P. Viola, and A. McCallum, Interactive information extraction with constrained conditional random fields, In Proceedings Of The 19th International Conference On Artificial Intelligence, AAAI, pages 412-418, 2004). In cases where there are multiple errors, a single user correction can be propagated to correct multiple errors automatically.

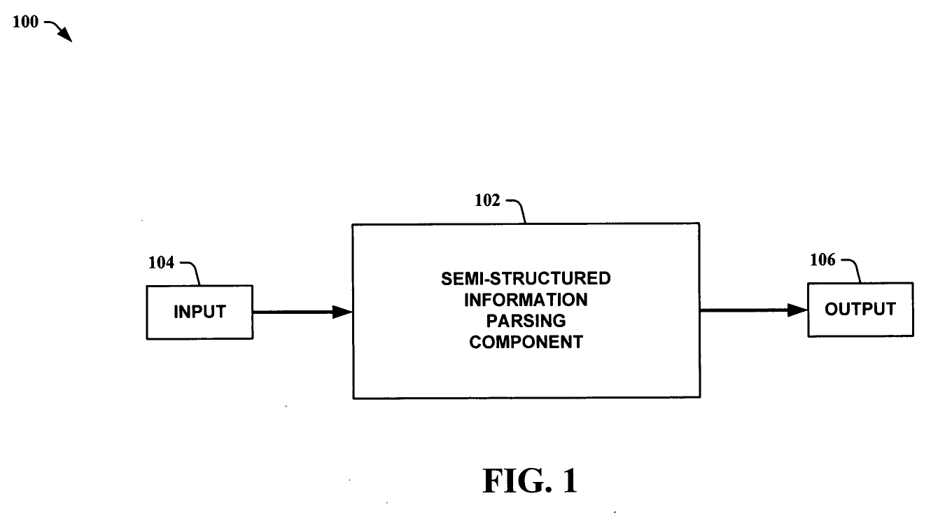

In FIG. 1, a block diagram of a semi-structured information parsing system 100 in accordance with an aspect of the subject invention is shown. The semi-structured information parsing system 100 is comprised of a semi-structured information parsing component 102 that receives an input 104 and provides an output 106. The input 104 can be unstructured information such as, for example, text, audio, and/or image data and the like. Typically, even with unstructured information, there is some type of general theme or pattern that can be extracted from the information. This is considered “semi-structured” because although, for example, the format of the information can be completely different, similar types or “classes” of information can be extracted utilizing the semi-structured information parsing system 100. For example, résumé information includes name, address, and experience. However, each person may have formatted their resume completely different from everyone else's. The semi-structured information parsing component 102 can still extract this information from the differing résumés. Likewise, it 102 can extract personal contact information from emails and documents and even extract bibliography information as well (despite differing formats and locations). The output 106 can be, for example, an optimal parse tree for the input 104. Thus, the semi-structured information parsing component 102 can extract data from semi-structured information to facilitate, for example, database entry tasks and the like.

The semi-structured information parsing component 102 accomplishes data extraction by utilizing a discriminatively learned context free grammar. Thus, the input 104 can contain training data that is utilized to train the grammar model that facilitates the semi-structured information parsing component 102 to properly score parses to obtain an optimal parse tree for the output 106. Classification algorithms provided by the subject invention are based on discriminatively trained CFGs that allow improved ability to incorporate expert knowledge (e.g., structure of a database and/or form), are less likely to be overtrained, and are more robust to variations in tokenization algorithms. Instances of the subject invention can also utilize user interaction to facilitate in parsing the input 104.

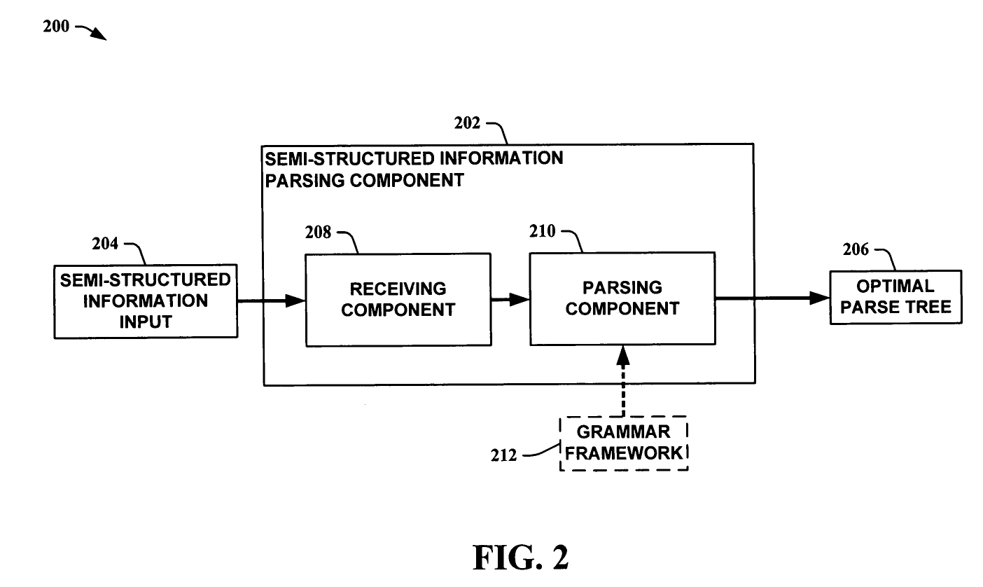

Referring to FIG. 2, another block diagram of a semi-structured information parsing system 200 in accordance with an aspect of the subject invention is depicted. The semi-structured information parsing system 200 is comprised of a semi-structured information parsing component 202 that receives a semi-structured information input 204 and provides an optimal parse tree 206. The semi-structured information parsing component 202 is comprised of a receiving component 208 and a parsing component 210. The receiving component 208 receives the semi-structured information input 204 and relays it to the parsing component 210. In other instances, the functionality of the receiving component 208 can reside within the parsing component 210 so that it 210 can directly receive the semi-structured information input 204. The parsing component 210 utilizes machine learning such as, for example, a perceptron-based technique to train a context free grammar discriminatively. The parsing component 210 employs the trained CFG to facilitate in parsing the semi-structured information input 204 to provide the optimal parse tree 206. In order to facilitate the training process of the CFG, the parsing component 210 can also receive an optional grammar framework 212 that provides a basic grammar for a set of semi-structured information. The parsing component 210 can then utilize the optional grammar framework 212 as a starting point for a training process. In other instances, the parsing component 210 can automatically construct the grammar framework 212 from training information that is part of the semi-structured information input 204.

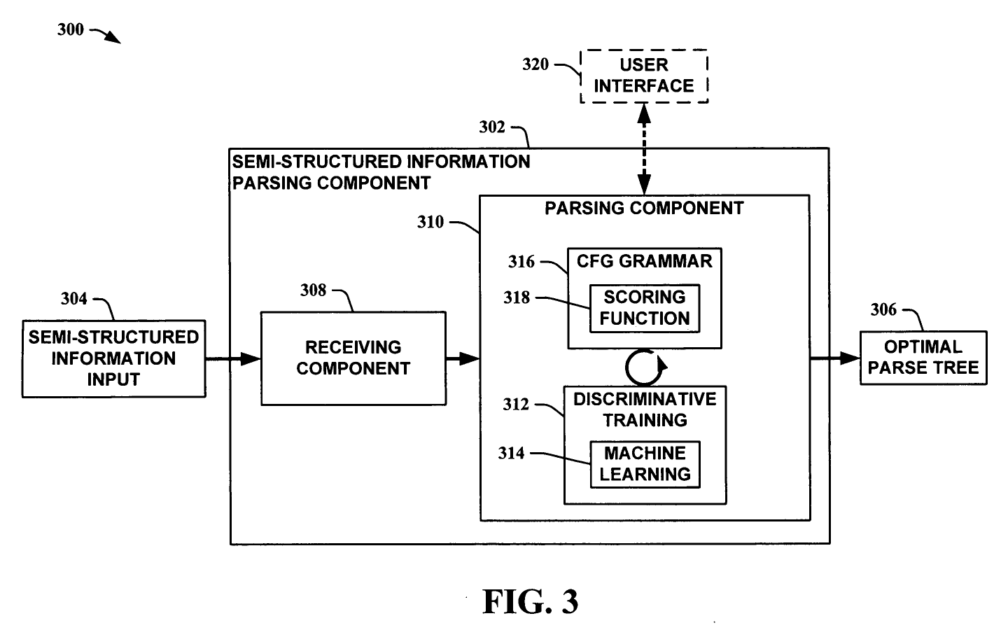

Looking at FIG. 3, yet another block diagram of a semi-structured information parsing system 300 in accordance with an aspect of the subject invention is illustrated. The semi-structured information parsing system 300 is comprised of a semi-structured information parsing component 302 that receives a semi-structured information input 304 and provides an optimal parse tree 306. The semi-structured information parsing component 302 is comprised of a receiving component 308, a parsing component 310 with a CFG grammar 316 and a grammatical scoring function 318, and discriminative training 312 with machine learning 314. The receiving component 308 receives the semi-structured information input 304 and relays it to the parsing component 310. In other instances, the functionality of the receiving component 308 can reside within the parsing component 310 so that it 310 can directly receive the semi-structured information input 304. The parsing component 310 utilizes discriminative training 312 to train the CFG grammar 316 to provide the optimal parse tree 306. The CFG grammar 316 utilizes the grammatical scoring function 318 to score parses in order to determine an optimal parse.

The discriminative training 312 facilitates in determining parameters for the CFG grammar 316 that optimize the grammatical scoring function 318. The discriminative training 312 utilizes machine learning such as, for example, a perceptron-based technique and the like discussed in detail infra. One skilled in the art can appreciate that the functionality of the discriminative training 312 can also reside outside of the parsing component 310. The parsing component 310 optimizes the CFG grammar 318 by selecting features of a set of semi-structured information that facilitate in eliminating and/or reducing ambiguities during parsing. The CFG grammar 316 then learns these features to enable data extraction from the semi-structured information input 304.

The parsing component 310 can also interact with an optional user interface 320. This allows a user to provide feedback to the parsing process. For example, labels utilized within the CFG grammar 316 can be displayed to a user. The user can then review the labels and determine if they are valid for the desired data extraction. This feedback is then utilized by the parsing component 310 to increase parsing performance of the semi-structured information input 304. This aspect can also be utilized with correction propagation to automatically improve the parsing process based on minimal interaction with a user.

In recent work, conditional Markov chain models (CMM) have been used to extract information from semi-structured text (one example is the Conditional Random Field (see, John Lafferty, Andrew McCallum, and Fernando Pereira, Conditional random fields: Probabilistic models for segmenting and labeling sequence data, In Proc. 18th International Conf. on Machine Learning, pages 282-289, Morgan Kaufmann, San Francisco, Calif., 2001)). Applications ranged from finding the author and title in research papers to finding the phone number and street address in a web page. The CMM framework combines a priori knowledge encoded as features with a set of labeled training data to learn an efficient extraction process. Instances of the subject invention, however, provide substantial advantages over these prior works as detailed infra.

Learning Semi-Structured Data Extraction

Consider the problem of automatically populating forms and databases with information that is available in an electronic but unstructured format. While there has been a rapid growth of online and other computer accessible information, little of this information has been schematized and entered into databases so that it can be searched, integrated and reused. For example, a recent study shows that as part of the process of gathering and managing information, currently 70 million workers, or 59% of working adults in the U.S., complete forms on a regular basis as part of their job responsibilities.

One common example is the entry of customer information into an online customer relation management system. In many cases, customer information is already available in an unstructured form on web sites and in email. The challenge is in converting this semi-structured information into the regularized or schematized form required by a database system. There are many related examples including the importation of bibliography references from research papers and extraction of resume information from job applications. For example applications of the systems and methods described infra, the source of the semi-structured information is considered to be from “raw text.” The same approach can be extended to work with semi-structured information derived from scanned documents (image based information) and/or voice recordings (audio based information) and the like.

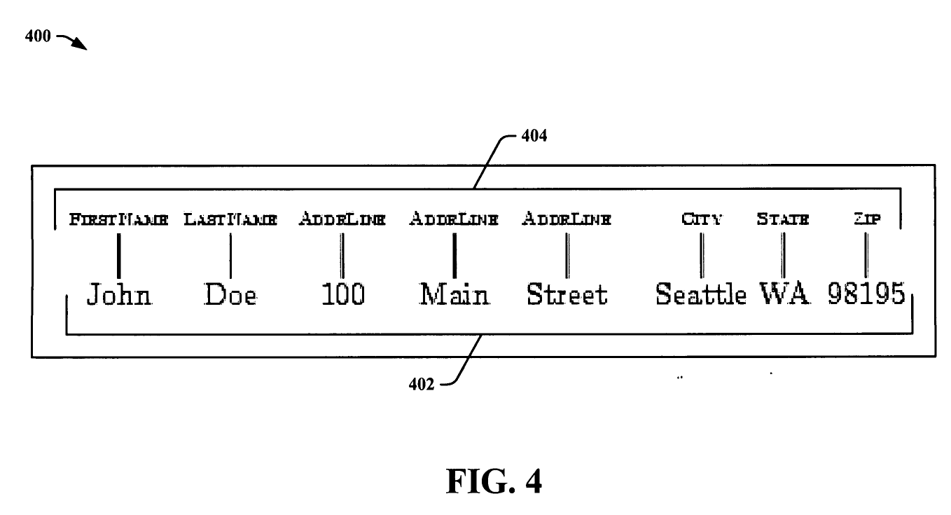

Contact information appears routinely in the signature of emails, on web pages, and on fax cover sheets. The form of this information varies substantially; from a simple name and phone number to a complex multi-line block containing addresses, multiple phone numbers, emails, and web pages. Effective search and reuse of this information requires field extraction such as LASTNAME, FIRSTNAME, STREETADDRESS, CITY, STATE, POSTALCODE, HOMEPHONENUMBER etc. One way of doing this is to consider a text block 400 as a sequence 402 of words/tokens, and assign labels 404 (e.g., fields of the database) to each of these tokens (see FIG. 4). All the tokens corresponding to a particular label are then entered, for example, into the corresponding field of a database. In this simple manner, a token classification algorithm can be used to perform schematization. Common approaches for classification include maximum entropy models and Markov models.

The systems and methods herein utilize a classification algorithm based on discriminatively trained context free grammars (CFG) that significantly outperforms prior approaches. Besides achieving substantially higher accuracy rates, a CFG based approach is better able to incorporate expert knowledge (such as the structure of the database and/or form), less likely to be overtrained, and is more robust to variations in the tokenization algorithm.

Semi-Structured Data Recognition

Free-form contact information such as that found on web pages, emails and documents typically does not follow a rigid format, even though it often follows some conventions. The lack of a rigid format makes it hard to build a non-statistical system to recognize and extract various fields from this semi-structured data. Such a non-statistical system might be built for example by using regular expressions and lexicon lists to recognize fields. One such system is described in J. Stylos, B. A. Myers, and A. Faulring, Citrine: providing intelligent copy-and-paste, In Proceedings of ACM Symposium on User Interface Software and Technology (UIST 2004), pages 185-188, 2005. This system looks for individual fields such as phone numbers by matching regular expressions, and recognizing other fields by the presence of keywords such as “Fax,” “Researcher,” etc., and by their relative position within the block (for example, it looks in the beginning for a name). However, because of spelling (or optical character recognition) errors and incomplete lexicon lists, even the best of deterministic systems are relatively inflexible, and hence break rather easily. Further, there is no obvious way for these systems to incorporate and propagate user input or to estimate confidences in the labels.

A simple statistical approach might be to use a Naive Bayes classifier to classify (label) each word individually. However, such classifiers have difficulties using features which are not independent. Maximum entropy classifiers (see, Stylos, Myers, and Faulring 2005) can use arbitrarily complex, possibly dependent features, and tend to significantly outperform Naive Bayes classifiers when there is sufficient data. A common weakness of both these approaches is that each word is classified independently of all others. Because of this, dependencies between labels cannot be used for classification purposes. To see that label dependencies can help improve recognition, consider the problem of assigning labels to the word sequence “GREWTER JONES.” The correct label sequence is FIRSTNAME LASTNAME. Because GREWTER is an unusual name, classifying it in isolation is difficult. But since JONES is very likely to be a LASTNAME, this can be used to infer that GREWTER is probably a FIRSTNAME. Thus, a Markov dependency between the labels can be used to disambiguate the first token.

Markov models explicitly capture the dependencies between the labels. A Hidden Markov Model (HMM) (see, L. R. Rabiner, A tutorial on hidden markov models, In Proc. of the IEEE, volume 77, pages 257-286, 1989) models the labels as the states of a Markov chain, with each token a probabilistic function of the corresponding label. A first order Markov chain models dependencies between the labels corresponding to adjacent tokens. While it is possible to use higher order Markov models, they are typically not used in practice because such models require much more data (as there are more parameters to estimate), and require more computational resources for learning and inference. A drawback of HMM based approaches is that the features used must be independent, and hence complex features (of more than one token) cannot be used. Some papers exploring these approaches include Vinajak R. Borkar, Kaustubh Deshmukh, and Sunita Sarawagi, Automatically extracting structure from free text addresses, In Bulletin of the IEEE Computer Society Technical committee on Data Engineering, IEEE, 2000; Remco Bouckaert, Low level information extraction: A bayesian network based approach, In Proc. Text ML 2002, Sydney, Australia, 2002; Rich Caruana, Paul Hodor, and John Rosenberg, High precision information extraction, In KDD-2000 Workshop on Text Mining, August 2000; Claire Cardie and David Pierce, Proposal for an interactive environment for information extraction, Technical Report TR98-1702, 2, 1998; Tobias Scheffer, Christian Decomain, and Stefan Wrobel, Active hidden markov models for information extraction, In Advances in Intelligent Data Analysis, 4th International Conference, IDA 2001, 2001; and Fei Sha and Fernando Pereira, Shallow parsing with conditional random fields, In Marti Hearst and Mari Ostendorf, editors, HLT-NAACL: Main Proceedings, pages 213-220, Edmonton, Alberta, Canada, 2003, Association for Computational Linguistics.

A Conditional Markov Model (CMM) (see, Lafferty, McCallum, and Pereira 2001; M. Collins, Discriminative training methods for hidden markov models: Theory and experiments with perceptron algorithms, In Proceedings of Empirical Methods in Natural Language Processing (EMNLP02), 2002; and B. Tasker, D. Klein, M. Collins, D. Koller, and C. Manning, Max-margin parsing, In Empirical Methods in Natural Language Processing (EMNLP04), 2004) is a discriminative model that is a generalization of both maximum entropy models and HMMs. Formally, they are undirected graphical models used to compute the joint score (sometimes as a conditional probability) of a set of nodes designated as hidden nodes given the values of the remaining nodes (designated as observed nodes). The observed nodes correspond to the tokens, while the hidden nodes correspond to the (unknown) labels corresponding to the tokens. As in the case of HMMs, the hidden nodes are sequentially ordered, with one link between successive hidden nodes. While an HMM model is generative, the conditional Markov model is discriminative. The conditional Markov model defines the joint score of the hidden nodes given the observed nodes. This provides the flexibility to use complex features which can be a function of any or all of the observed nodes, rather than just the observed node corresponding to the hidden node. Like the Maximum Entropy models the conditional Markov model uses complex features. Like the HMM the CMM can model dependencies between labels. In principle a CMMs can model third or fourth order dependencies between labels though most published papers use first order models because of data and computational restrictions.

Variants of conditional Markov models include Conditional Random Fields (CRFs) (see, Lafferty, McCallum, and Pereira 2001), voted perceptron models (see, Collins 2002), and max-margin Markov models (see, Tasker, Klein, Collins, Koller, and Manning 2004). CRFs are the most mature and have shown to perform extremely well on information extraction tasks (see, Andrew McCallum and Wei Li, Early results for named entity recognition with conditional random fields, feature induction and web-enhanced lexicons, In Marti Hearst and Mari Ostendorf, editors, HLT-NAACL, Edmonton, Alberta, Canada, 2003, Association for Computational Linguistics; David Pinto, Andrew McCallum, Xing Wei, and W. Bruce Croft, Table extraction using conditional random fields, In Proceedings of the ACM SIGIR, 2003; Kamal Nigam, John Lafferty, and Andrew McCallum, Using maximum entropy for text classification, In IJCAI'99 Workshop on Information Filtering, 1999; Andrew McCallum, Efficiently inducing features of conditional random fields, In Nineteenth Conference on Uncertainty in Artificial Intelligence (UAI03), 2003; and Sha and Pereira 2003). A CRF model is used in Kristjansson, Culotta, Viola, and McCallum 2004 to label tokens corresponding to contact blocks, to achieve significantly better results than prior approaches to this problem.

Grammar Based Modeling

While CMMs can be very effective, there are clear limitations that arise from the “Markov” assumption. For example, a single “unexpected” state/label can throw the model off. Further, these models are incapable of encoding some types of complex relationships and constraints. For example, in a contact block, it may be quite reasonable to expect only one city name. However, since a Markov model can only encode constraints between adjacent labels, constraints on labels that are separated by a distance of more than one cannot be easily encoded without an explosion in the number of states (possible values of labels), which then complicates learning and decoding.

Modeling non-local constraints is very useful, for example, in the disambiguation of business phone numbers and personal phone numbers. To see this, consider the two contact blocks shown in TABLE 1. In the first case, it is natural to label the phone number as a HOMEPHONENUMBER. In the second case, it is more natural to label the phone number as a BUSINESSPHONENUMBER. Humans tend to use the labels/tokens near the beginning to distinguish the two. Therefore, the label of the last token depends on the label of the first token. There is no simple way of encoding this very long-range dependency with any practical Markov model.

TABLE 1
Disambiguation of Phone Numbers

| Fred Jones | Boston College |
|---|---|
| 10 Main St. | 10 Main St. |
| Cambridge, MA 02146 | Cambridge MA 02146 |
| (425) 994-8021 | (425) 994-8021 |

A grammar based model allows parsing processes to “escape the linear tyranny of these n-gram models and HMM tagging models” (see, C. D. Manning and H. Schütze, Foundations of Statistical Natural Language Processing, The MIT Press, 1999). A context-free grammar allows specification of more complex structure with long-range dependencies, while still allowing for relatively efficient labeling and learning from labeled data. One possible way to encode the long-range dependence required for the above example might be to use a grammar which contains different productions for business contacts, and personal contacts. The presence of the productions (BIZCONTACT→BIZNAME ADDRESS BIZPHONE) and (PERSONALCONTACT+NAME ADDRESS HOMEPHONE) would allow the system to infer that the phone number in the first block is more likely to be a HOMEPHONE while the phone number in the second is more likely to be a BUSINESSPHONE. The correct/optimal parse of the blocks automatically takes the long-range dependencies into account naturally and efficiently.

As another example, imagine a system which has a detailed database of city and zip code relationships. Given a badly misspelled city name, there may be many potential explanations (such as a first name or company name). If the address block contains an unambiguous zip code, this might provide the information necessary to realize that “Noo Yick” is actually the city “New York.” This becomes especially important if there is some ambiguity with regards to the tokens themselves (which might occur for example if the tokens are outputs of a speech recognition system, or an image based system). Therefore, if the name of the city is misspelled, or incorrectly recognized, the presence of an unambiguous zip code can be utilized to make better predictions about the city. In a simple linear-chain Markov model, if the state appears between the city and the zip, the dependence between the zip and the city is lost.

Labeling using CMMs has been used as an approximation to, and as an intermediate step in, many important shallow parsing problems including NP-chunking. While CMMs achieve reasonably good accuracy, the accuracy provided by a full blown statistical parser is often higher. The main advantage of a CMM is computational speed and simplicity. However, it is more natural to model a contact block using a CFG than a CMM. This is because a contact block is more than just a sequence of words. There is clearly some hierarchical structure to the block. For example, the bigram FIRSTNAME LASTNAME can be recognized as a NAME as can LASTNAME, IRSTNAME . Similarly, an ADDRESS can be of the form STREETADDRESS, CITY STATE ZIP and also of the form STREETADDRESS. It intuitively makes sense that these different forms occur (with different probabilities) independently of their context. While this is clearly an approximation to the reality, it is perhaps a better approximation than the Markov assumption underlying chain-models.

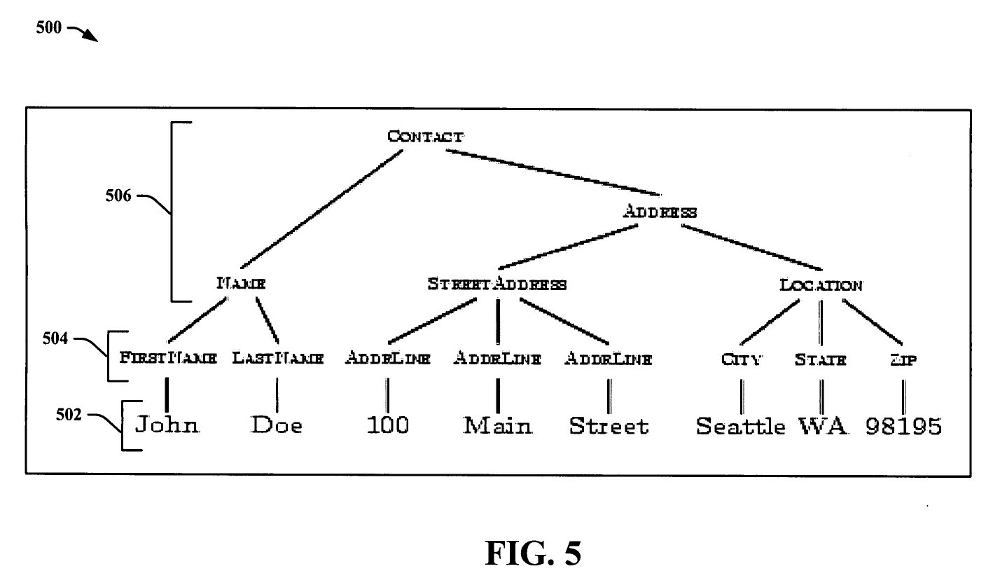

The grammatical parser accepts a sequence of tokens, and returns the optimal (lowest cost or highest probability) parse tree corresponding to the tokens. FIG. 5 shows a parse tree 500 for the sequence of tokens shown in FIG. 4. The leaves 502 of the parse tree 500 are the tokens. Each leaf has exactly one parent, and parents 504 of the leaves are the labels of the leaves. Therefore, going from a parse tree to the label sequence is very straightforward. Note that the parse tree represents a hierarchical structure 506 beyond the labels. This hierarchy is not artificially imposed, but rather occurs naturally. Just like a language model, the substructure NAME and ADDRESS can be arranged in different orders: both NAME ADDRESS and ADDRESS NAME are valid examples of a contact block. The reuse of components allows the grammar based approach to more efficiently generalize from limited data than a linear-chain based model. This hierarchical structure is also useful when populating forms with more than one field corresponding to a single label. For example, a contact could have multiple addresses. The hierarchical structure allows a sequence of tokens to be aggregated into a single address, so that different addresses could be entered into different fields.

Discriminative Context-Free Grammars

A context free grammar (CFG) consists of a set of terminals {w^{k}}ₖ₌₁^{V}, a set of nonterminals {N^{j}}ᵢ₋₁ⁿ, a designated start symbol N¹, and a set of rules or productions {Rᵢ: N^{j}^{ᵢ}→ξⁱ}ᵢ₌₁^{r} where ξⁱ is a sequence of terminals and nonterminals. A score S(Rᵢ) is associated with each rule Rᵢ. A parse tree is a tree whose leaves are labeled by terminals and interior nodes are labeled by nonterminals. Further if a node N^{j}^{ᵢ} is the label of a interior node, then the child nodes are the terminals/nonterminals in ξⁱ where Rᵢ: N^{j}^{ᵢ}→ξ^{f}. The score of a parse tree T is given by Σ_{{R}_{ᵢ}_{:N}_{^{ji}}_{→ξ}_{ⁱ}_{}εT} S(N^{j}^{ᵢ}→ξⁱ). A parse tree for a sequence w₁w₂ . . . wₘ is a parse tree whose leaves are w₁w₂ . . . wₘ. Given the scores associated with all the rules, and a given sequence of terminals w₁w₂ . . . wₘ, the CKY algorithm can compute the highest scoring parse tree in time O(m³·n·r), which is reasonably efficient when m is relatively small.

Generative models such as probabilistic CFGs can be described using this formulation by taking S(Rᵢ) to be the logarithm of the probability P(Rᵢ) associated with the rule. If the probability P(Rᵢ) is a log-linear model and N^{j}^{ᵢ} can be derived from the sequence wₐ wₐ₊₁, . . . w_{b} (also denoted N^{j}^{ᵢ}z,900 wₐwₐ₊₁, . . . w_{b}), then P(Rᵢ) can be written as:

$$\frac{1}{{Z}_{( λ ( {R}_{i} ) , a , b , {R}_{i} )}} exp {\sum }_{k = 1}^{F} {λ}_{k} ( {R}_{i} ) {f}_{k} ( {w}_{a} , {w}_{a + 1} , … , {w}_{b ,} {R}_{i} ) ; \qquad ( Eq . 1 )$$

{fₖ}ₖ₌₁^{F} is the set of features and λ(Rᵢ) is a vector of parameters representing feature weights (possibly chosen by training). Z_{(λ,a,b,N}_{ⁱ}_{→ξ}_{ⁱ}₎ is called the partition function and is chosen to ensure that the probabilities add up to 1.

In order to learn an accurate generative model, a lot of effort has to be spent learning the distribution of the generated leaf sequences. Since the set of possible leaf sequences are very large, this requires a large amount of training data. However, in the applications of interest, the leaves are typically fixed, and interest lies only in the conditional distribution of the rest of the parse tree given the leaves. Therefore, if only the conditional distribution (or scores) of the parse trees given the leaves are learned, considerably less data (and less computational effort) can be required.

A similar observation has been made in the machine learning community. Many of the modern approaches for classification are discriminative (e.g., Support Vector Machines (see, Corinna Cortes and Vladimir Vapnik, Support-vector networks, Machine Learning, 20(3):273-297, 1995) and AdaBoost (see, Y. Freund and R. E. Schapire, Experiments with a new boosting algorithm, In International Conference on Machine Learning, pages 148-156, 1996). These techniques typically generalize better than generative techniques because they only model the boundary between classes (which is closely related to the conditional distribution of the class label), rather than the joint distribution of class label and observation.

A generative model defines a language, and associates probabilities with each sentence in the language. In contrast, a discriminative model only associates scores with the different parses of a particular sequence of terminals. Computationally there is little difference between the generative and discriminative model—the complexity for finding the optimal parse tree (the inference problem) is identical in both cases. For the discriminative model utilized by instances of the systems and methods herein, the scores associated with the rule Rᵢ: N^{j}^{ᵢ} are given by:

$$S ( {R}_{i} ) = {\sum }_{k = 1}^{F} {λ}_{k} ( {R}_{i} ) {f}_{k} ( {w}_{1} {w}_{2} … {w}_{m} , a , b , {R}_{i} ) ; \qquad ( Eq . 2 )$$

when applied to the sequence wₐwₐ₊₁ . . . w_{b}. Note that in this case the features can depend on all the tokens, not just the subsequence of tokens spanned by N^{j}^{ᵢ}. The discriminative model allows for a richer collection of features because independence between the features is not required. Since a discriminative model can always use the set of features that a generative model can, there is always a discriminative model which performs at least as well as the best generative model. In many experiments, discriminative models tend to outperform generative models.
Grammar Construction

As mentioned supra, the hierarchical structure of contact blocks is not arbitrary. It is fairly natural to combine a FIRSTNAME and a LASTNAME to come up with a NAME. This leads to the rule NAME→FIRSTNAME LASTNAME. Other productions for NAME include:
NAME→LASTNAME, FIRSTNAME
NAME→FIRSTNAME MIDDLENAME LASTNAME
NAME→FIRSTNAMENICKNAMELASTNAME
   NAME can be built on by modeling titles and suffixes using productions FULLNAME→NAME, FULLNAME→TITLE NAME SUFFIX. Other rules can be constructed based on commonly occurring idioms. For example, LOCATION→CITY STATE ZIP can occur. Such a grammar can be constructed by an “expert” after examining a number of examples.

Alternatively, an automatic grammar induction technique can be used. Instances of the systems and methods herein can employ a combination of the two. For example, based on a database of 1,487 labeled examples of contact records drawn from a diverse collection of sources, a program extracted commonly occurring “idioms” or patterns. A human expert then sifted through the generated patterns to decide which made sense and which did not. Most of the rules generated by the program, especially those which occurred with high frequency, made sense to the human expert. The human expert also took some other considerations into account, such as the requirement that the productions were to be binary (though the productions were automatically binarized by another program). Another requirement was imposed by training requirements described infra.

Feature Selection

The features selected included easily definable functions like word count, regular expressions matching token text (like CONTAINSNEWLINE, CONTAINSHYPHEN, CONTAINSDIGITS, PHONENUMLIKE), tests for inclusion in lists of standard lexicons (for example, US first names, US last names, commonly occurring job titles, state names, street suffixes), etc. These features are mostly binary and are definable with minimal effort. They are similar to those used by the CRF model described in Kristjansson, Culotta, Viola, and McCallum 2004. However in the CRF model, and in all CMMs, the features can only relate the sequence of observations wᵢ, the current state sₜ, the previous state sₜ₋₁), and the current time t (i.e., fⱼ(sₜ,sₜ₋₁, wᵢ, w₁, . . . , wₘ,t)).

In contrast, the discriminative grammar admits additional features of the form fₖ(w₁, w₁, . . . , wₘ, a, b, c, N^{j}^{ᵢ}→ξⁱ), where N^{j}^{ᵢ} spans wₐwₐ₊₁ . . . w_{b}. In principle, these features are much more powerful because they can analyze the sequence of words associated with the current non-terminal. For example, consider the sequence of tokens Mavis Wood Products. If the first and second tokens are on a line by themselves, then Wood is more likely to be interpreted as a LASTNAME. However, if all three are on the same line, then they are more likely to be interpreted as part of the company name. Therefore, a feature ALLONTHESAMELINE (which when applied to any sequence of words returns 1 if they are on the same line) can help the CFG disambiguate between these cases. This type of feature cannot be included in a conditional Markov model.

Generating Labeled Data

The standard way of training a CFG is to use a corpus annotated with tree structure, such as the Penn Tree-bank (see, M. Marcus, G. Kim, M. Marcinkiewicz, R. Maclntyre, A. Bies, M. Ferguson, K. Katz, and B. Schasberger, The penn treebank: Annotating predicate argument structure, 1994). Given such a corpus, algorithms based on counting can be used to determine the probabilities (parameters) of the model. However, annotating the corpora with the tree-structure is typically done manually which is time consuming and expensive in terms of human effort.

In contrast, the data required for training the Markov models are the sequences of words and the corresponding label sequences. At first, it may appear that there would be significant added work in generating a parse tree for each label for a grammar based system. Below, it is demonstrated how the parse tree required for training the grammars can be automatically generated from just the label sequences for a certain class of grammars.

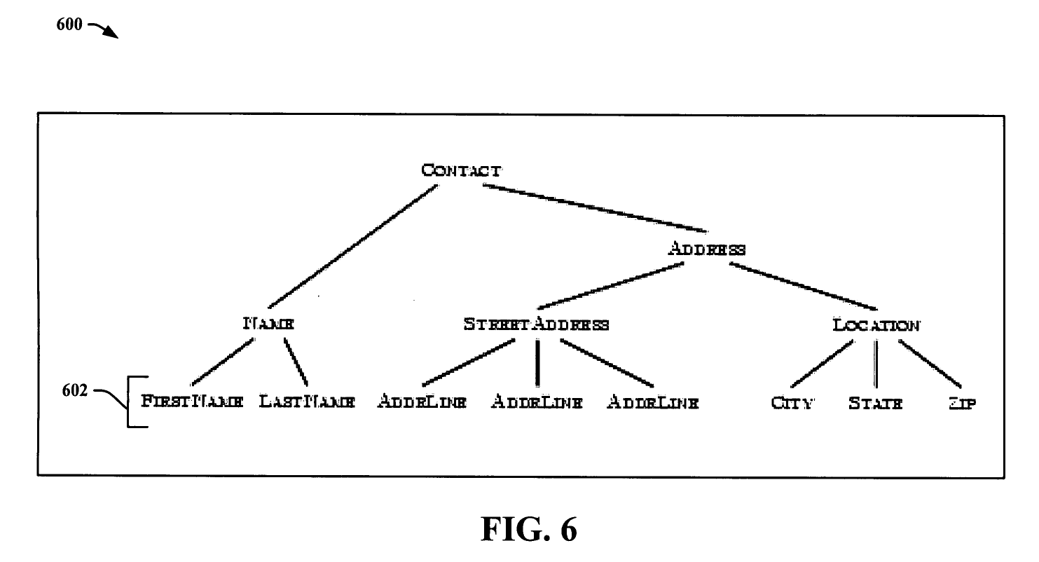

Given a parse tree T for a sequence w₁w₂ . . . wₘ, let the reduced parse tree T′ be the tree obtained by deleting all the leaves of T. FIG. 6 shows the reduced parse tree 600 obtained from FIG. 5. In this reduced parse tree 600, the label sequence lᵢl₂ . . . lₘ corresponds to the leaves 602. This reduced tree 600 can be thought of as the parse tree of the sequence l₁l₂ . . . lₘ over a different grammar in which the labels are the terminals. This new grammar is easily obtained from the original grammar by simply discarding all rules in which a label occurs on the LHS (left hand side). If G′ is the reduced grammar, G′ can be utilized to parse any sequence of labels. Note that G′ can parse a sequence l₁l₂ . . . lₘ if and only if there is a sequence of words w₁w₂ . . . wₘ with lᵢ being the label of wᵢ·G is label-unambiguous if G′ is unambiguous (i.e., for any sequence l₁l₂ . . . lₘ, there is at most one parse tree for this sequence in G′). To generate a parse tree for a label unambiguous grammar, given the label, the following two step process can be employed.
1. Generate a (reduced) parse tree for the label sequence using the reduced grammar G′.
2. Glue on the edges of the form lᵢ→wᵢ to the leaves of the reduced tree.
   Given any sequence of words w₁ . . . wₘ and their corresponding labels l₁ . . . lₘ, this method yields a parse tree for w₁ . . . wₘ which is compatible with the label sequence l₁ . . . lₘ (if one exists). Therefore, this method allows generation of a collection of parse trees given a collection of labeled sequences.

Doing this has at least two advantages. First, it allows for a direct like-to-like comparison with the CRF based methods since it requires no additional human effort to generate the parse trees (i.e., both models can work on exactly the same input). Secondly, it ensures that changes in grammar do not require human effort to generate new parse trees.

There is a natural extension of this algorithm to handle the case of grammars that are not label-unambiguous. If the grammar is not label-unambiguous, then there could be more than one tree corresponding to a particular labeled example. In this case, an arbitrary tree can be selected or possibly a tree that optimizes some other criterion. An EM-style algorithm can also be utilized to learn a probabilistic grammar for the reduced grammar. Experimentation with some grammars with moderate amounts of label-ambiguity utilized a tree with the smallest height. Performance degradation was not observed for these cases of moderate amounts of ambiguity.

Grammar Training

The goal of training is to find the parameters λ that maximize some optimization criterion, which is typically taken to be the maximum likelihood criterion for generative models. A discriminative model assigns scores to each parse, and these scores need not necessarily be thought of as probabilities. A good set of parameters maximizes the “margin” between correct parses and incorrect parses. One way of doing this is using the technique described in Tasker, Klein, Collins, Koller, and Manning 2004. However, a simpler algorithm can be utilized by the systems and methods herein to train the discriminative grammar. This algorithm is a variant of the perceptron algorithm and is based on the algorithm for training Markov models proposed by Collins (see, Collins 2002).

Suppose that T is the collection of training data {(wⁱ, l^{a},T^{a})|1≦i≦m}, where wⁱ=w₁ⁱw₂ⁱ . . . wₙ_{ᵢ} is a sequence of words, lⁱ=l₁ⁱl₂ⁱ . . . lₙ_{ᵢ}ⁱ is a set of corresponding labels, and Tⁱ is the parse tree. For each rule R in the grammar, a setting of the parameters λ(R) is sought so that the resulting score is maximized for the correct parse Tⁱ of wⁱ for 0≦i≦m. This algorithm for training is shown in TABLE 2 below. An analysis of this “perceptron-like” algorithm appears in Y. Freund and R. Schapire, Large margin classification using the perceptron algorithm, Machine Learning, 37(3):277-296 and Collins 2002 when the data is separable. In Collins 2002 some, generalization results for the inseparable case are also given to justify the application of the algorithm.

TABLE 2
Adapted Perceptron Training Algorithm

```
for r [symbol] 1 ... numRounds do
  for i [symbol] 1 ... m do
    T [symbol] optimal parse of wⁱ with current parameters
    if T ≠ Tⁱ then
      for each rule R used in T but not in Tⁱ do
        if feature fⱼ is active in wⁱ then
          λⱼ(R) [symbol] λⱼ(R) − 1;
        endif
      endfor
      for each rule R used in T^{j} but not in T do
        if feature fⱼ is active in wⁱ then
          λⱼ(R) [symbol] λⱼ(R) + 1;
        endif
      endfor
    endif
  endfor
endfor
```

This technique can be extended to train on the N-best parses, rather than just the best. In this case, the N-best parses are returned from the parsing algorithm. Adapting the algorithm of Table 2, the weight for the rules and features in the correct parse are increased: λⱼ(R)←λⱼ(R)+1; while the weights for the rules and features in the incorrect parses are decreased: λⱼ(R)←λⱼ(R)−1.

It can also be extended to train all sub-parses as well (i.e., parameters are adjusted so that the correct parse of a sub-tree is assigned the highest score). For each sub-tree of the correct solution, examine the chart entry that corresponds to that subsequence of the input. The weight for the rules and features in the correct sub-tree are increased: λⱼ(R)←λⱼ(R)+1; while the weights for the rules and features in the incorrect parses of that sub-tree are decreased: λⱼ(R)←λⱼ(R)−1.

Correction Propagation

Kristjansson, et al., introduced the notion of correction propagation for interactive form filling tasks (see, Kristjansson, Culotta, Viola, and McCallum 2004). In this scenario, the user pastes unstructured data into the form filling system and observes the results. Errors are then quickly corrected using a drag and drop interface. After each correction, the remaining observations can be relabeled so as to yield the labeling of lowest cost constrained to match the corrected field (i.e., the corrections can be propagated). For inputs containing multiple labeling errors, correction propagation can save significant effort. Any score minimization framework such as a CMM or CFG can implement correction propagation. The main value of correction propagation can be observed on examples with two or more errors. In the ideal case, a single user correction should be sufficient to accurately label all the tokens correctly.

Suppose that the user has indicated that the token w, actually has label lᵢ . . . The CKY algorithm can be modified to produce the best parse consistent with this label. Such a constraint can actually accelerate parsing, since the search space is reduced from the set of all parses to the set of all parses in which wᵢ has label lᵢ. CKY returns the optimal constrained parse in the case where all alternative non-terminals are removed from the cell associated with wᵢ.

The systems and methods herein apply the powerful tools of statistical natural language processing to the analysis of non-natural language text. A discriminatively trained context free grammar can more accurately extract contact information than a similar conditional Markov model.

There are several advantages provided by CFG systems and methods. The CFG, because its model is hierarchically structured, can generalize from less training data. For example, what is learned about BUSINESSPHONENUMBER can be shared with what is learned about HOMEPHONENUMBER, since both are modeled as PHONENUMBER. The CFG also allows for a rich collection of features which can measure properties of a sequence of tokens. The feature ALLONONELINE is a very powerful clue that an entire sequence of tokens has the same label (e.g., a title in a paper, or a street address). Another advantage is that the CFG can propagate long range label dependencies efficiently. This allows decisions regarding the first tokens in an input to effect the decisions made regarding the last tokens. This propagation can be quite complex and multi-faceted.

The effects of these advantages are many. For example a grammar based approach also allows for selective retraining of just certain rules to fit data from a different source. For example, Canadian contacts are reasonably similar to US contacts, but have different rules for postal codes and street addresses. In addition, a grammatical model can encode a stronger set of constraints (e.g., there should be exactly one city, exactly one name, etc.). Grammars are much more robust to tokenization effects, since the two tokens which result from a word which is split erroneously can be analyzed together by the grammar's sequence features. Additionally, the application domain for discriminatively trained context free grammars is quite broad. It is possible to analyze a wide variety of semi-structured forms such as resumes, tax documents, SEC filings, and research papers and the like.

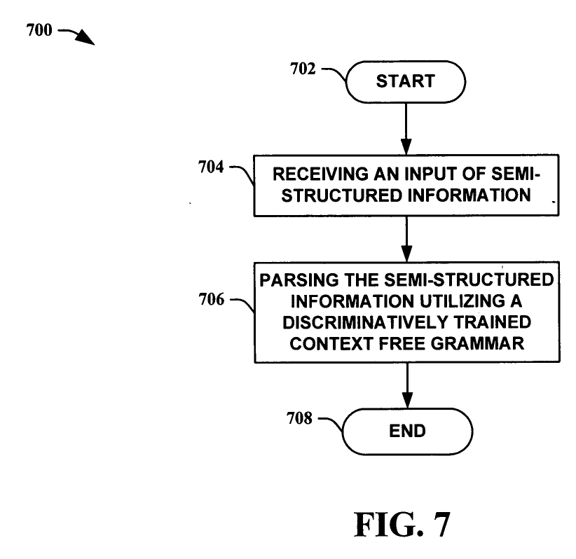

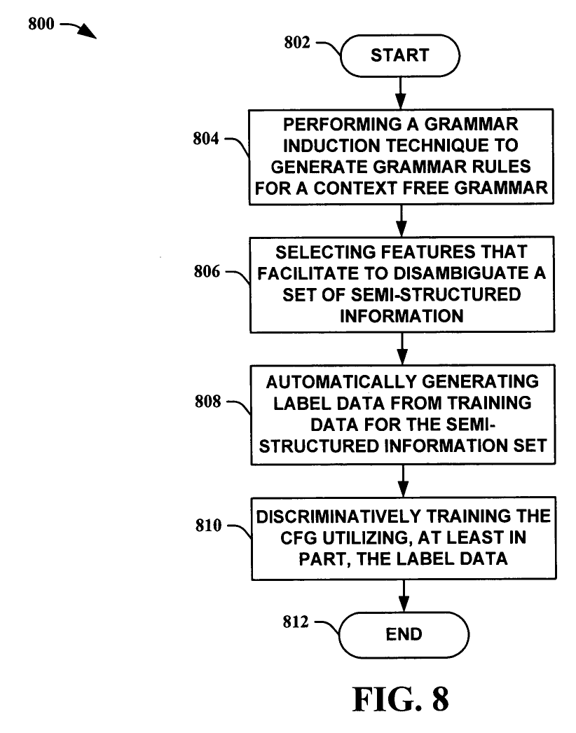

In view of the exemplary systems shown and described above, methodologies that may be implemented in accordance with the subject invention will be better appreciated with reference to the flow charts of FIGS. 7 and 8. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

In FIG. 7, a flow diagram of a method 700 of facilitating semi-structured information parsing in accordance with an aspect of the subject invention is shown. The method 700 starts 702 by receiving an input of semi-structured information 704. The semi-structured information can include, but is not limited to, personal contact information and/or bibliography information and the like. The source of the information can be emails, documents, and/or résumés and the like. Semi-structured information typically is information that has a general theme or form but the data itself may not always be in the same format. For example, a resume usually contains a name, address, telephone, and background experience. However, the manner in which the information is placed within the résumé can vary greatly from person-to-person. Likewise, personal contact information can be found at the bottom of a web page and/or in a signature line of an email. It may contain a single phone number or multiple phone numbers. The name can include business names and the like as well. Thus, the general theme is contact information but the manner and format of the information can vary substantially and/or be placed in different sequences with long range dependencies.

The semi-structured information is then parsed utilizing a discriminately trained context free grammar (CFG) 706, ending the flow 708. Parsing the data typically involves segmentation and labeling of the data. The subject invention provides a learning grammar that facilitates the parsing to achieve an optimal parse tree. Discriminative techniques typically generalize better than generative techniques because they only model boundary between classes, rather than the joint distribution of class label and observation. This combined with the training via machine learning allows instances of the subject invention substantial flexibility in accepting different semi-structured information. The context free grammar rules can be trained to accept a wide range of information formats and/or trained to distinguish between key properties that facilitate in reducing ambiguities.

Turning to FIG. 8, a flow diagram of a method 800 of discriminatively training a context free grammar (CFG) in accordance with an aspect of the subject invention is illustrated. The method 800 starts 802 by performing a grammar induction technique to generate grammar rules 804. The induction technique can be accomplished manually and/or automatically. Thus, one instance utilizes a combination of both, first by automatically generating commonly occurring idioms or patterns, then through sorting by a human expert. The induction technique provides a framework for a basic grammar. Features are then selected that facilitate to disambiguate a set of semi-structured information 806. In order to properly parse the set of semi-structured information, the selected features should be chosen such that they can distinguish between cases that would otherwise prove ambiguous. Thus, proper selection of features can substantially enhance the performance of the process.

Label data is then automatically generated from training data for the semi-structured information set 808. Traditional label data generation requires manual annotation of the corpora with the tree structure, time consuming and expensive in terms of human effort. By automatically accomplishing this task, it ensures that changes in grammar do not require human effort to generate new parse trees for labeled sequences. A context free grammar is then discriminatively trained utilizing, at least in part, the generated label data 810, ending the flow 812. The goal of training is to determine parameters that maximize an optimization criterion. This can be, for example, the maximum likelihood criterion for generative models. However, discriminative models assign scores to each parse, and these scores need not necessarily be probabilities. Typically, a “good” set of parameters maximizes the margin between correct parses and incorrect parses. One instance utilizes a perceptron-based technique to facilitate the training of the CFG. This is described in detail supra.

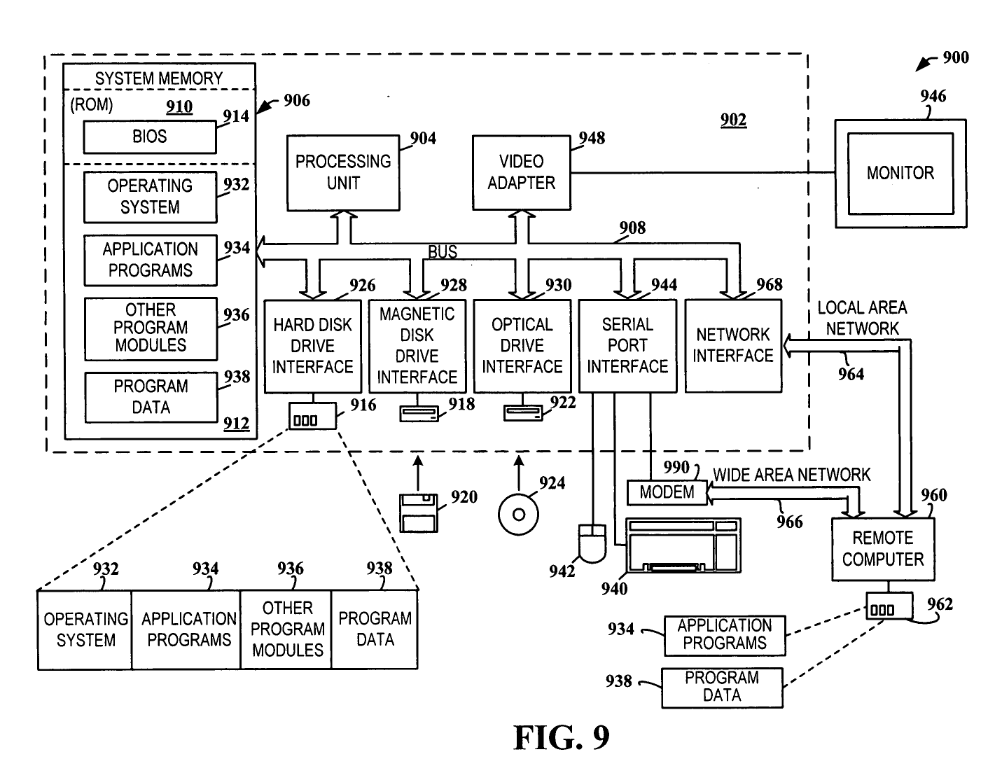

In order to provide additional context for implementing various aspects of the subject invention, FIG. 9 and the following discussion is intended to provide a brief, general description of a suitable computing environment 900 in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 9, an exemplary system environment 900 for implementing the various aspects of the invention includes a conventional computer 902, including a processing unit 904, a system memory 906, and a system bus 908 that couples various system components, including the system memory, to the processing unit 904. The processing unit 904 may be any commercially available or proprietary processor. In addition, the processing unit may be implemented as multi-processor formed of more than one processor, such as may be connected in parallel.

The system bus 908 may be any of several types of bus structure including a memory bus or memory controller, a peripheral bus, and a local bus using any of a variety of conventional bus architectures such as PCI, VESA, Microchannel, ISA, and EISA, to name a few. The system memory 906 includes read only memory (ROM) 910 and random access memory (RAM) 912. A basic input/output system (BIOS) 914, containing the basic routines that help to transfer information between elements within the computer 902, such as during start-up, is stored in ROM 910.

The computer 902 also may include, for example, a hard disk drive 916, a magnetic disk drive 918, e.g., to read from or write to a removable disk 920, and an optical disk drive 922, e.g., for reading from or writing to a CD-ROM disk 924 or other optical media. The hard disk drive 916, magnetic disk drive 918, and optical disk drive 922 are connected to the system bus 908 by a hard disk drive interface 926, a magnetic disk drive interface 928, and an optical drive interface 930, respectively. The drives 916-922 and their associated computer-readable media provide nonvolatile storage of data, data structures, computer-executable instructions, etc. for the computer 902. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 900, and further that any such media may contain computer-executable instructions for performing the methods of the subject invention.

A number of program modules may be stored in the drives 916-922 and RAM 912, including an operating system 932, one or more application programs 934, other program modules 936, and program data 938. The operating system 932 may be any suitable operating system or combination of operating systems. By way of example, the application programs 934 and program modules 936 can include a recognition scheme in accordance with an aspect of the subject invention.

A user can enter commands and information into the computer 902 through one or more user input devices, such as a keyboard 940 and a pointing device (e.g., a mouse 942). Other input devices (not shown) may include a microphone, a joystick, a game pad, a satellite dish, a wireless remote, a scanner, or the like. These and other input devices are often connected to the processing unit 904 through a serial port interface 944 that is coupled to the system bus 908, but may be connected by other interfaces, such as a parallel port, a game port or a universal serial bus (USB). A monitor 946 or other type of display device is also connected to the system bus 908 via an interface, such as a video adapter 948. In addition to the monitor 946, the computer 902 may include other peripheral output devices (not shown), such as speakers, printers, etc.

It is to be appreciated that the computer 902 can operate in a networked environment using logical connections to one or more remote computers 960. The remote computer 960 may be a workstation, a server computer, a router, a peer device or other common network node, and typically includes many or all of the elements described relative to the computer 902, although for purposes of brevity, only a memory storage device 962 is illustrated in FIG. 9. The logical connections depicted in FIG. 9 can include a local area network (LAN) 964 and a wide area network (WAN) 966. Such networking environments are commonplace in offices, enterprise-wide computer networks, intranets and the Internet.

When used in a LAN networking environment, for example, the computer 902 is connected to the local network 964 through a network interface or adapter 968. When used in a WAN networking environment, the computer 902 typically includes a modem (e.g., telephone, DSL, cable, etc.) 970, or is connected to a communications server on the LAN, or has other means for establishing communications over the WAN 966, such as the Internet. The modem 970, which can be internal or external relative to the computer 902, is connected to the system bus 908 via the serial port interface 944. In a networked environment, program modules (including application programs 934) and/or program data 938 can be stored in the remote memory storage device 962. It will be appreciated that the network connections shown are exemplary and other means (e.g., wired or wireless) of establishing a communications link between the computers 902 and 960 can be used when carrying out an aspect of the subject invention.

In accordance with the practices of persons skilled in the art of computer programming, the subject invention has been described with reference to acts and symbolic representations of operations that are performed by a computer, such as the computer 902 or remote computer 960, unless otherwise indicated. Such acts and operations are sometimes referred to as being computer-executed. It will be appreciated that the acts and symbolically represented operations include the manipulation by the processing unit 904 of electrical signals representing data bits which causes a resulting transformation or reduction of the electrical signal representation, and the maintenance of data bits at memory locations in the memory system (including the system memory 906, hard drive 916, floppy disks 920, CD-ROM 924, and remote memory 962) to thereby reconfigure or otherwise alter the computer system's operation, as well as other processing of signals. The memory locations where such data bits are maintained are physical locations that have particular electrical, magnetic, or optical properties corresponding to the data bits.

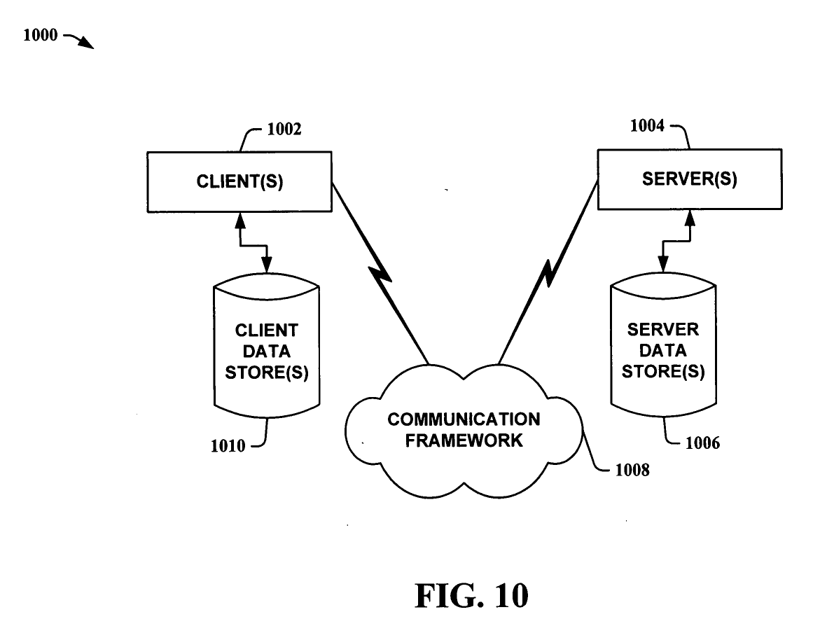

FIG. 10 is another block diagram of a sample computing environment 1000 with which the subject invention can interact. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 may be in the form of a data packet adapted to be transmitted between two or more computer processes. The system 1000 includes a communication framework 1008 that can be employed to facilitate communications between the client(s) 1002 and the server(s) 1004. The client(s) 1002 are connected to one or more client data store(s) 1010 that can be employed to store information local to the client(s) 1002. Similarly, the server(s) 1004 are connected to one or more server data store(s) 1006 that can be employed to store information local to the server(s) 1004.

It is to be appreciated that the systems and/or methods of the subject invention can be utilized in recognition facilitating computer components and non-computer related components alike. Further, those skilled in the art will recognize that the systems and/or methods of the subject invention are employable in a vast array of electronic related technologies, including, but not limited to, computers, servers and/or handheld electronic devices, and the like.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates recognition, comprising:
a receiving component that receives an input of semi-structured information; and
a parsing component that parses the semi-structured information utilizing a discriminatively trained context free grammar.

2. The system of claim 1, the parsing component employs a perceptron-based learning rule to facilitate in learning a parse scoring function.

3. The system of claim 2, the parsing component trains the scoring function based on N-best parses, where N is an integer from one to infinity.

4. The system of claim 2, the parsing component trains the scoring function based on at least one subparse.

5. The system of claim 2, the parsing component interacts with a user to facilitate in parsing the semi-structured information.

6. The system of claim 1, the semi-structured information comprising semi-structured text, semi-structured information derived from images, and/or semi-structured information derived from audio.

7. The system of claim 6, the semi-structured text comprising text from an email, text from a document, text from a bibliography, and/or text from a resume.

8. A method for facilitating recognition, comprising:
receiving an input of semi-structured information; and
parsing the semi-structured information utilizing a discriminatively trained context free grammar.

9. The method of claim 8 further comprising:
constructing a discriminatively trained context free grammar.

10. The method of claim 9, the construction of the discriminatively trained context free grammar comprising:
performing a grammar induction process to generate a set of grammar rules to construct a context free grammar;
selecting a set of features that facilitate to disambiguate a set of semi-structured information;
generating label data automatically from a set of training data for the semi-structured information set; and
training the context free grammar discriminatively utilizing, at least in part, the label data.

11. The method of claim 8 further comprising:
utilizing correction propagation to facilitate in parsing the semi-structured information.

12. The method of claim 8 further comprising:
interfacing with a user to obtain at least one correction associated with the parsing of the semi-structured information.

13. The method of claim 8 further comprising:
parsing the input based on a grammatical scoring function; the grammatical scoring function derived, at least in part, via a machine learning technique that facilitates in determining an optimal parse.

14. The method of claim 13, the machine learning technique comprising a perceptron-based learning technique.

15. The method of claim 14, the perceptron-based learning technique comprising:
setting parameters λ(R) for each rule R in the grammar to obtain a maximized resulting score for a correct parse of Tⁱ of wⁱ for 0≦i≦m; where T is a collection of training data {(wⁱ, l^{a}, T^{a})|1≦i≦m}, wⁱ=w₁ⁱw₂ⁱ . . . wₙ_{ᵢ}ⁱ is a collection of components, lⁱ=l₁ⁱl₂ⁱ . . . lₙ_{ᵢ}ⁱ is a set of corresponding labels, and Tⁱ is a parse tree.

16. The method of claim 13 further comprising:
training a scoring function based on N-best parses, where N is an integer from one to infinity.

17. The method of claim 13 further comprising:
training a scoring function based on at least one subparse.

18. A system that facilitates recognition, comprising:
means for receiving an input of semi-structured information; and
means for parsing the semi-structured information utilizing a discriminatively trained context free grammar.

19. The system of claim 18 further comprising:
means for parsing the semi-structured information utilizing at least one classifier trained via a machine learning technique.

20. A database system employing the method of claim 8. 1
